(19) United States
(12) Patent Application Publication
(10) Pub. No.: US 2022/0095716 A1
(43) Pub. Date: Mar. 31, 2022

(54) FOLDED MASK

(71) Applicant: Patrick Vidal, Playa del Rey, CA (US)

(72) Inventor: Patrick Vidal, Playa del Rey, CA (US)

(21) Appl. No.: 17/490,626

(22) Filed: Sep. 30, 2021

Related U.S. Application Data
(60) Provisional application No. 63/085,821, filed on Sep. 30, 2020.

(51) Int. Cl. A41D 13/11

(52) U.S. Cl. CPC A41D 13/1107; A41D 2400/42; A41D 13/1161

(57) ABSTRACT

Described herein is a wearable mask. The mask includes a nose bridge construction of a shape that allows for effective sealing without the need for gaskets or other adjustable seals. The mask may be constructed from a flat pattern that requires a minimal amount of stitching while allowing the nose bridge to be properly shaped.

### CROSS-REFERENCE TO RELATED APPLICATION

This patent document claims the benefit of priority under 35 U.S.C. § 119 of U.S. Provisional Patent Application No. 63/085,821, titled “Folded Mask,” by Patrick Vidal, filed Sep. 30, 2021 (Attorney Docket No. PATVP001P), which is hereby incorporated by reference in its entirety for all purposes.

### BACKGROUND

The popularity of mask wearing is increasing. Though mask wearing is becoming more popular, masks typically require manual adjustment of gaskets to properly seal the area above the nose of the user's face. Furthermore, the size and shape of different faces of different users is challenging for a single mask to accommodate.

### SUMMARY

Described are methods and systems for a mask. The mask may include a front face including a forward facing portion and a rearward facing portion, where the rearward facing portion comprises a top edge, a nose bridge, triangular in cross-section and including a bottom portion, where the bottom portion is disposed along the top edge of the rearward facing portion of the front face, and where the front face and the nose bridge are bent from a continuous flat pattern, and stitching, disposed substantially parallel to the top edge and extending rearward and downward, where the stitching couples the front face to the nose bridge and holds in place the bottom portion of the nose bridge relative to the top edge.

In another embodiment, a method of forming the mask may be described. The method may include preparing a mask pattern, where the mask pattern includes a first portion, a second portion, and a concave portion defined by at least a first perimeter portion and a second perimeter portion disposed at a first angle to the first perimeter portion, where the first portion and the second portion are divided by a first bend line, and where the first bend line divides the mask pattern into left and right portions, bending downward a top portion of the mask pattern, bending the mask pattern along a bend line dividing the first portion and the second portion, pulling upward, from the mask pattern bent along the bend line, a nose bridge from the top portion that is bent downward, where pulling the nose bridge upward additionally defines at least a portion of a front face of the mask, and stitching the nose bridge to the front face of the mask, where the stitching is substantially parallel to a top edge of the front face.

Illustrative, non-exclusive examples of inventive features according to present disclosure are described herein. These and other examples are described further below with reference to figures.

### BRIEF DESCRIPTION OF THE DRAWINGS

The disclosure may best be understood by reference to the following description taken in conjunction with the accompanying drawings, which illustrate various examples.

FIGS. 1-7 illustrate representations from various angles of a first embodiment of a mask, in accordance with some examples.

FIGS. 8-14 illustrate representations from various angles of another embodiment of a mask, in accordance with some examples.

FIG. 15 illustrates a representation of a flat pattern for a mask, in accordance with some examples.

FIGS. 16-27 illustrate various steps of a technique of manufacturing a mask, in accordance with some examples.

### DETAILED DESCRIPTION

In the following description, numerous specific details are set forth in order to provide a thorough understanding of the presented concepts. The presented concepts may be practiced without some, or all, of these specific details. While some concepts will be described with the specific examples, it will be understood that these examples are not intended to be limiting.

Described herein is a wearable mask. The wearable mask may be for a user to wear in normal circumstances (e.g., during everyday life as fashion and/or to avoid viral infection and/or transmission), during activities (e.g., sports activities such as snowboarding or skiing), during work, and/or during another time. In various embodiments, the masks described herein include a nose bridge construction of a shape that allows for effective sealing without the need for gaskets or other adjustable seals. Instead, the nose bridge of the masks described herein is shaped to conform to a nose of a wearer. Furthermore, in various embodiments, the mask may be constructed from a flat pattern (e.g., a fabric flat pattern) that requires a minimal amount of stitching while allowing the nose bridge to be shaped as described herein.

In various portions of this disclosure, reference is made to directions such as “up” and “down.” Such directions may be relative to a user's face. Thus, for example, “up” may refer to the direction towards a user's eyes or hairline, from the mask. “Down” may refer to the direction towards the user's lower body, from the mask. Furthermore, “forward” may refer to a front facing portion of the mask while “rearward” may refer to a rear facing portion of the mask (e.g., towards the back of the user's head).

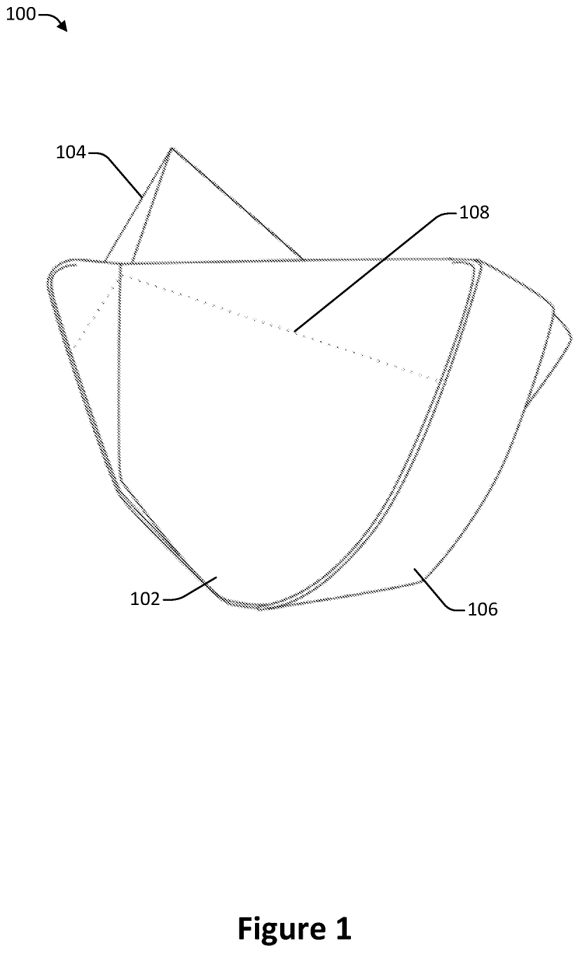

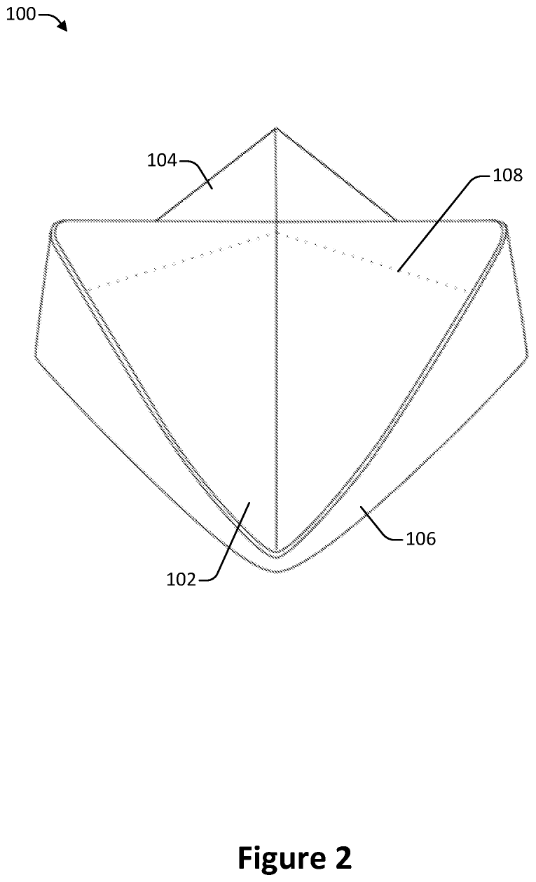

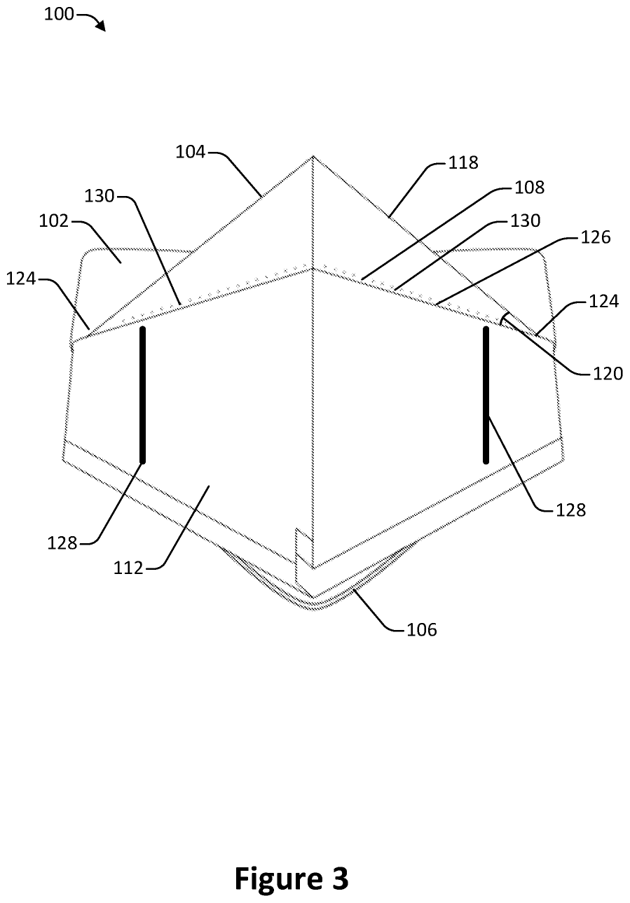

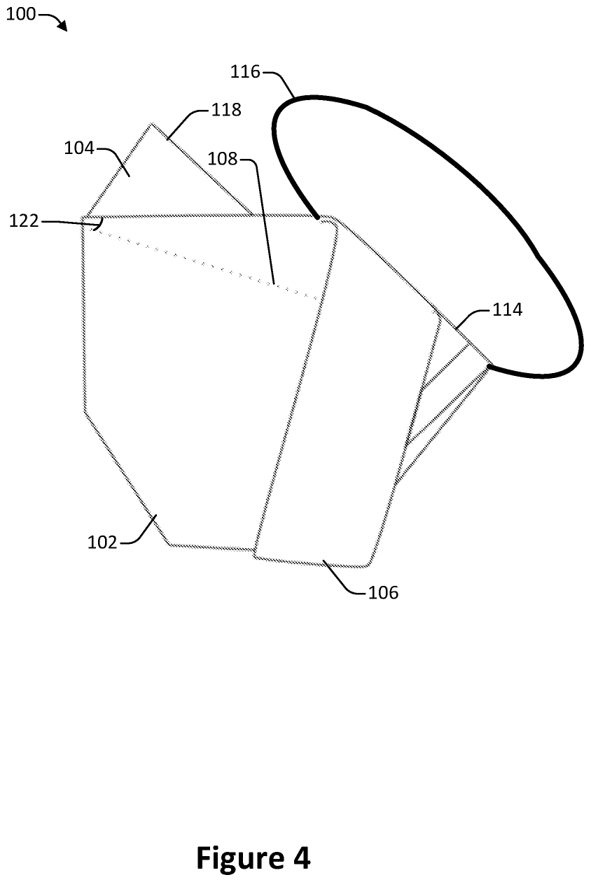

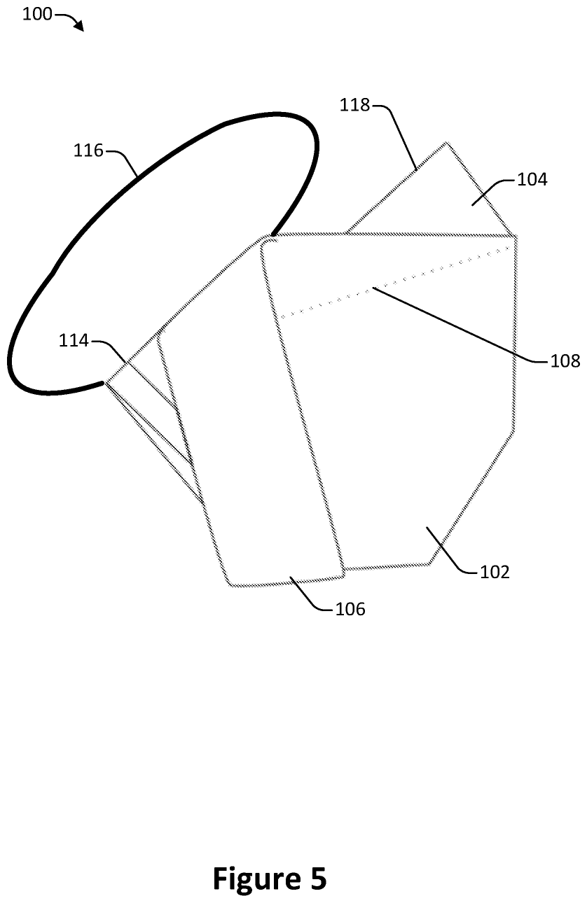

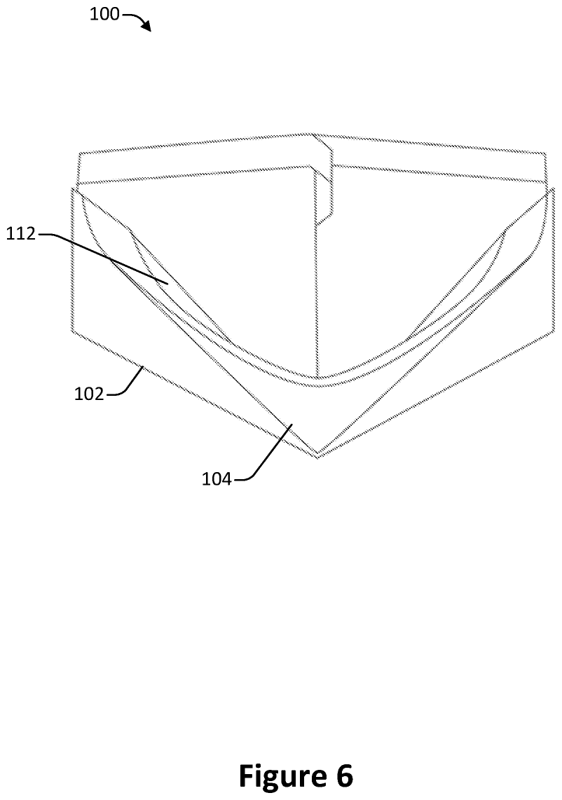

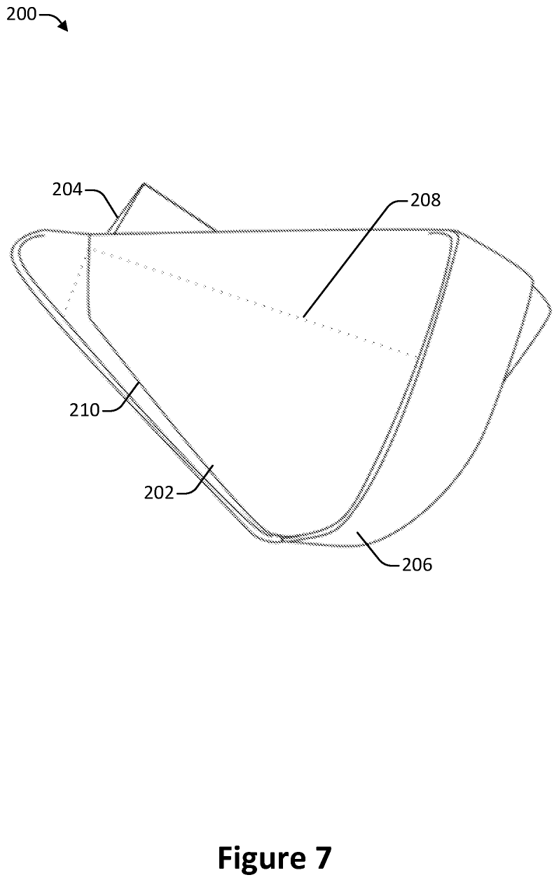

FIGS. 1-7 illustrate representations from various angles of a first embodiment of a mask, in accordance with some examples. FIGS. 1-7 illustrate a mask 100 that includes a front face 102, a nose bridge 104, wings 106, and stitching 108. FIG. 1 is an angled view of mask 100. FIG. 2 is a front view of mask 100. FIG. 3 is a rear view of mask 100. FIGS. 4 and 5 are left and right views of mask 100. FIG. 6 is a top view of mask 100. FIG. 7 is a bottom view of mask 100. In various embodiments, mask 100 may be a mask formed from one or more flat patterns, as described herein. Mask 100 may be a fabric or other material mask that may be configured to filter dust, debris, viruses, bacteria, and/or other objects.

In various embodiments, front face 102 may be configured to cover the front of a user's face, such as the user's mouth and/or nose. As such, front face 102 may cover a user's breathing orifices (e.g., mouth and nose) to prevent and/or minimize dust, debris, viruses, bacteria, and/or other objects from being breathed by the user and/or from being emitted by the user into the general environment (e.g., the airspace around the user).

In various embodiments, front face 102 may include a forward facing portion and a rearward facing portion. The rearward facing portion may be disposed closer to the user's face. Liner 112 may be coupled to the rearward facing portion, as shown in FIG. 4. In various embodiments, liner 112 may be, for example, sewn or otherwise coupled to the rearward facing portion of front face 102. Liner 112 may include pockets 128 (e.g., through openings on one or a plurality of sides of liner 112). In various embodiments, a filter may be inserted behind liner 112 (e.g., into pocket 128 formed at least partly by liner 112). The filter may be a replaceable filter. Thus, the pocket formed by liner 112 may accept a filter that may be replaced as needed. In certain other embodiments, removable insulation may be disposed within pocket 128. Such insulation may be, for example, made from a synthetic material that minimizes thermal transfer and/or a natural material such as wool. The insulation may be removable and/or layered as needed and may, for example, increase the warmth of the mask if the user is engaging in winter sports or activities.

Nose bridge 104 may be formed from the fabric and/or another material. Nose bridge 104 may be triangular in cross-section and its triangular cross-section may be held in place, relative to front face 102, by stitching 108. Stitching 108 may hold in place bottom portion 130 of nose bridge 104 relative to front face 102. In various embodiments, stitching 108 may follow an inner bottom edge of nose bridge 104 and may extend downward and rearward from a forward portion of front face 102.

In certain such embodiments, stitching 108 may dispose nose bridge 104 and front face 102 and/or liner 112 at an acute angle, such as angle 120. Angle 120 may be an acute angle, such as an angle of between 0 to 40 degrees. As stitching 108 may be substantially parallel (e.g., within +/−20 degrees of parallel) with a top edge 126 of liner 112 (which may define a fold line that defines nose bridge 104 relative to liner 112 and/or the rearward facing portion of front face 102), stitching 108 may thus be disposed at angle 120 relative to inner edge 118 (e.g., the topmost edge of nose bridge 104 resting above a user's nose) of nose bridge 104. Top edge 126 may be disposed substantially parallel to bottom portion 130. Stitching 108, inner edge 118, and top edge 126 may meet at portion 124. Meeting of stitching 108, inner edge 118, and top edge 126 may allow for nose bridge 104 to maintain a triangular shape and increase sealing. Angle 120 may be centered on portion 124.

The triangular cross-section of nose bridge 104 allows for nose bridge 104 to conform to a user's nose, which is also triangular, without the need for adjustable seals or other adjustable features. Thus, a good seal along the nose of the user may naturally be formed by nose bridge 104.

Wings 106 may be flaps on the side portions (e.g., left and right sides) of front face 102 and may be folded in a downward direction. Wings 106 may be formed by additional fabric due to the flat pattern of mask 100. In certain embodiments, strap 116, which is configured to hold mask 100 to a user's face, may be coupled to wings 106 and/or to rearward portion 114 of mask 100. Rearward portion 114 may be, for example, a portion of front face 102 that is bent downwards along with wings 106. Other embodiments may couple strap 116 to other portions of mask 100. Wings 106 may provide a location for variably affixing straps 116 (e.g., affixed in different locations depending on, for example, whether straps 116 are ear or head loops). Furthermore, wings 106 may also be used as a chin strap. Thus, wings 106 may pull in portions of front face 102 and/or another portion of mask 100. Wings 106 may, additionally or alternatively, provide structure to mask 100 (e.g., to maintain the shape of mask 100).

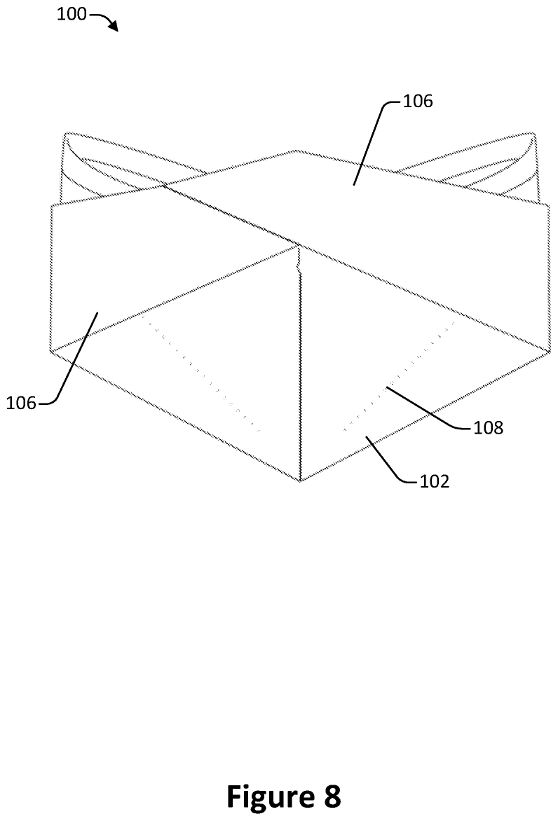

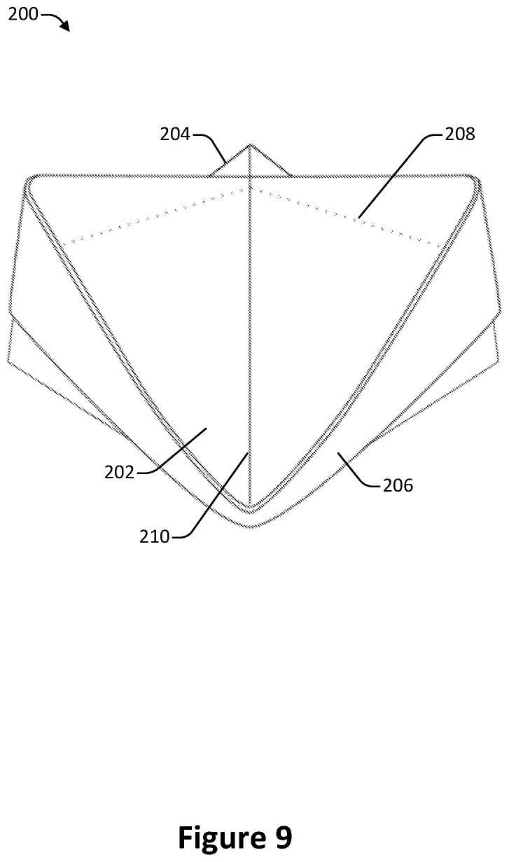

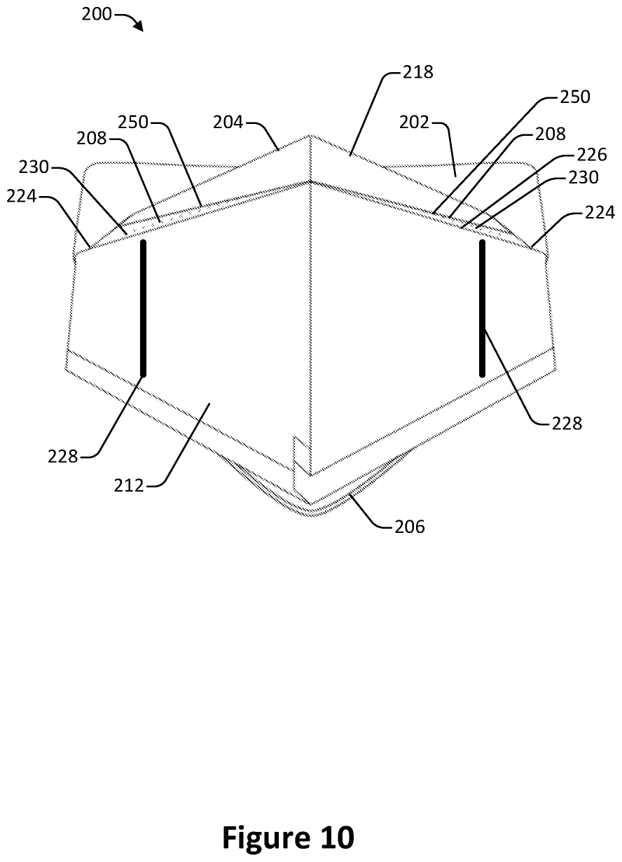

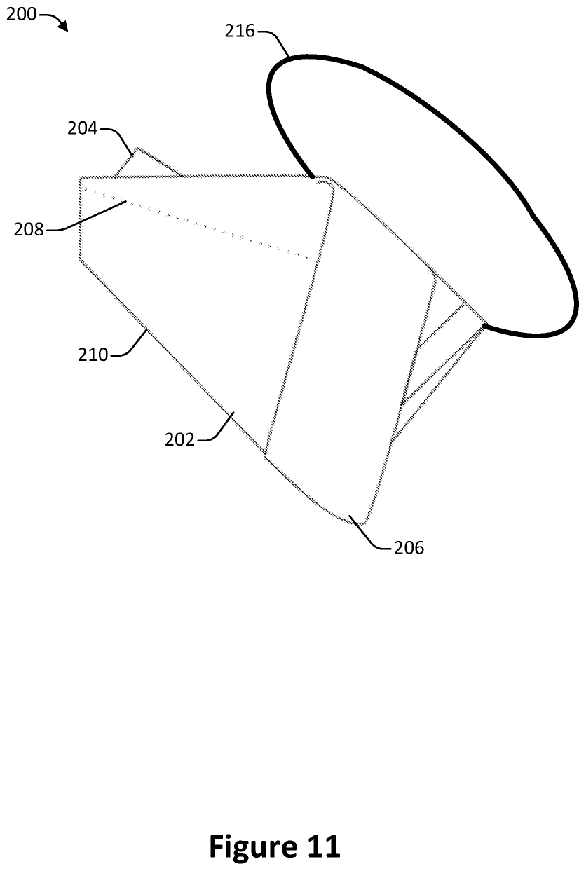

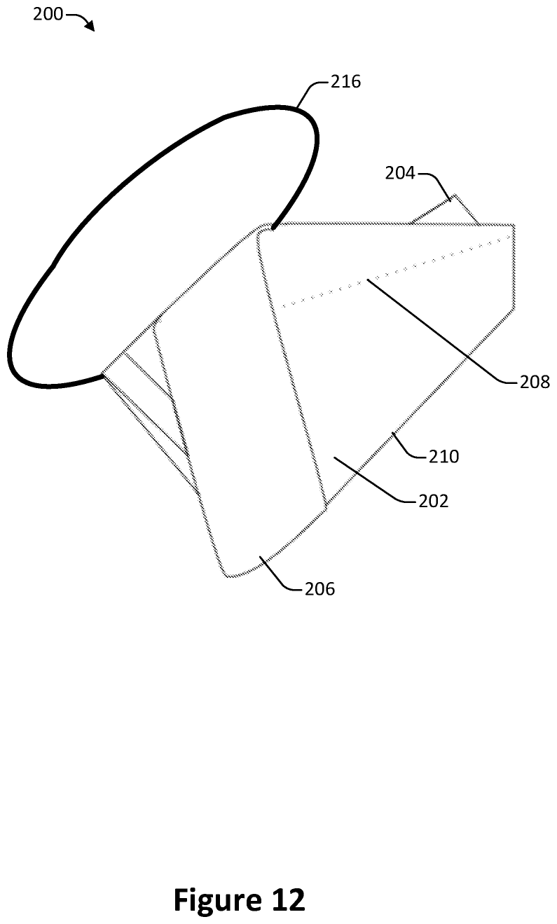

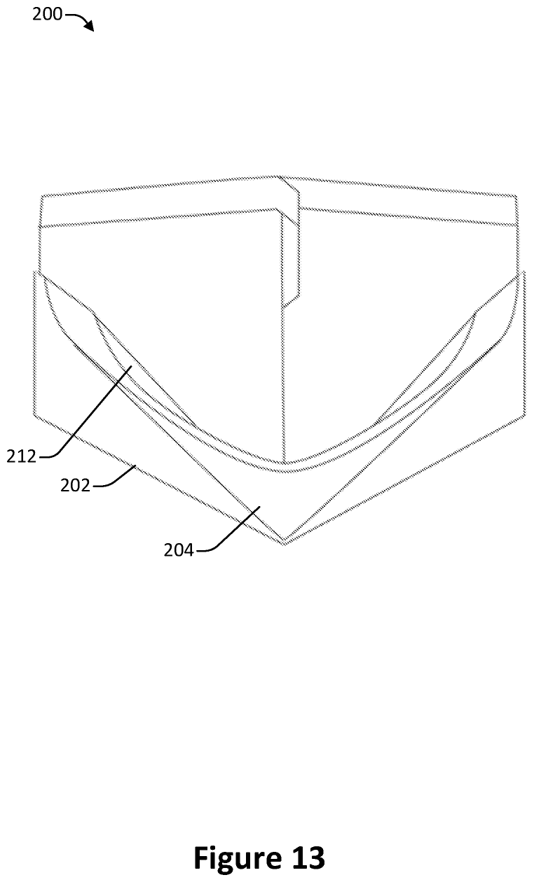

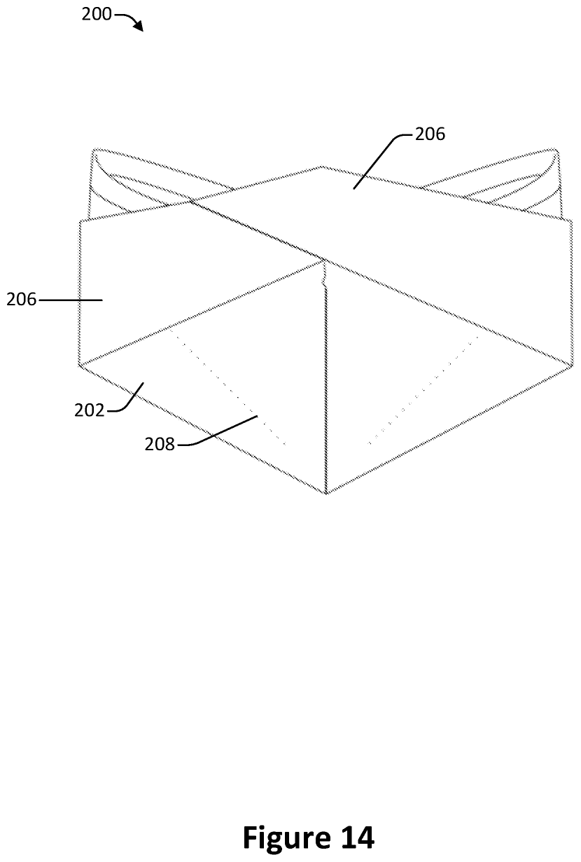

FIGS. 8-14 illustrate representations from various angles of another embodiment of a mask, in accordance with some examples. FIGS. 8-14 illustrate a tailored mask 200. Tailored mask 200 includes front face 202, nose bridge 204, wings 206, stitching 208, and strap 216.

Tailored mask 200 may further include liner 212 and pocket 228. Nose bridge 204 may include bottom portion 230 that may be disposed substantially parallel to top edge 226. Liner 212, stitching 208, and inner edge 218 of nose bridge 204 may meet around portion 224. Such features may be similar to equivalent liner 112, pocket 128, and inner edge 118 of FIGS. 1-7. In certain embodiments though, as nose bridge 204 is folded via folds 250, inner edge 218 of nose bridge 204 may be disposed at a more parallel angle relative to stitching 208 than inner edge 118 to stitching 108. In certain embodiments, stitching 208 may be substantially parallel (e.g., within +/−20 degrees of parallel) with inner edge 218. Such a configuration may increase sealing for users with certain facial features.

Front face 202 may cover the front of a user's face, similar to front face 102. Front face 202 may include portion 210. In tailored mask 200, portion 210 of front face 202 may be pulled inward relative to front face 102 through, for example, stitching features. Such a configuration of front face 202 allows for front face 202 to be closer to a user's face, decreasing the volume of airspace and increasing, for example, the heat retention of mask 200 and/or the amount of air within mask 200 that is filtered.

In certain additional embodiments, nose bridge 204 (and/or nose bridge 104) may be adjustable. Such adjustment may include, for example, adjusting the height of nose bridge 204 by the folding of nose bridge 204 via, for example, folds 250. As such, the height of nose bridge 204 may be adjusted to accommodate a user while still retaining the triangular cross-sectional shape of nose bridge 204.

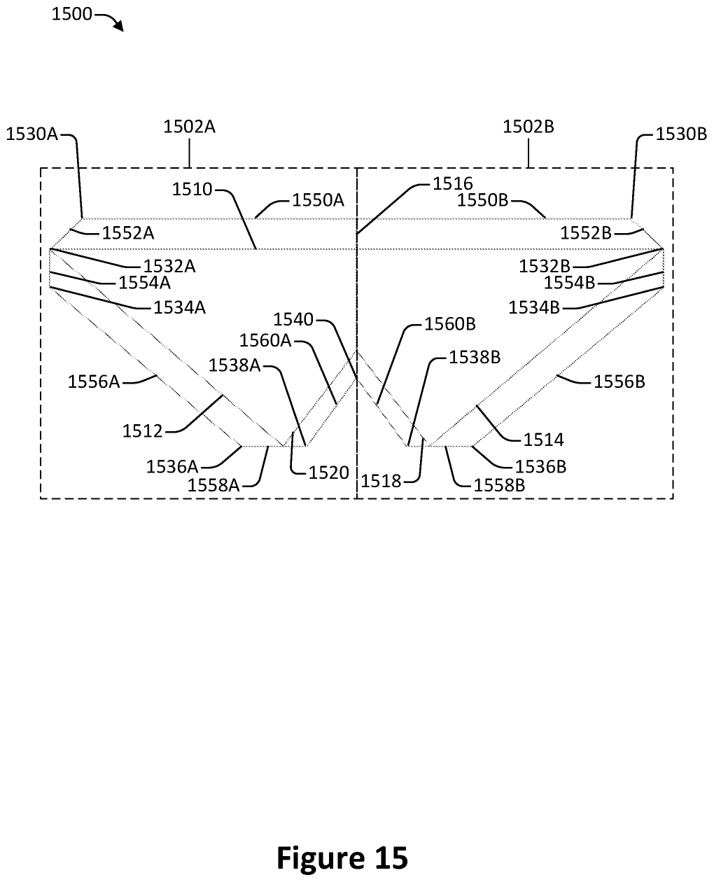

FIG. 15 illustrates a representation of a flat pattern for a mask, in accordance with some examples. FIG. 15 illustrates flat pattern 1500. Flat pattern 1500 includes portions 1502A and 1502B. In certain embodiments portions 1502A and 1502B may be substantially mirrored and may, for example, include similar features. The flat pattern of the mask may also be referred to as the mask pattern, especially when described in context where the flat pattern has been bent or shaped in one or more ways. In certain embodiments, each operation of forming the mask may create a new mask pattern, such as a first mask pattern, a second mask pattern, a third mask pattern, and so on, each of which sequentially conforms with the operation step of forming the mask.

Portion 1502A may be a shape that includes perimeter portions 1550A, 1552A, 1554A, 1556A, 1558A, and 1560A. Each of perimeter portions 1550A, 1552A, 1554A, 1556A, 1558A, and 1560A may be disposed at an angle relative to adjacent portions. Such angles may be less than 180 degrees. Thus, angles 1530A, 1532A, 1534A, 1536A, and 1538A may be defined by two of perimeter portions 1550A, 1552A, 1554A, 1556A, 1558A, and 1560A, as shown in FIG. 15. Such angles 1530A, 1532A, 1534A, 1536A, and 1538A may, in certain embodiments, each be obtuse angles. In various embodiments, perimeter portion 1550A and 1558A may be substantially (e.g., within +/−20 degrees of) parallel.

Portion 1502B may include similar perimeter portions 1550B, 1552B, 1554B, 1556B, 1558B, and 1560B joined by angles 1530B, 1532B, 1534B, 1536B, and 1538B. Perimeter portions 1550B, 1552B, 1554B, 1556B, 1558B, and 1560B and angles 1530B, 1532B, 1534B, 1536B, and 1538B may be similar to perimeter portions 1550A, 1552A, 1554A, 1556A, 1558A, and 1560A and angles 1530A, 1532A, 1534A, 1536A, and 1538A of portion 1502A, respectively. Perimeter portions 1550A and 1550B may be collinear. In various embodiments, perimeter portions 1560A and 1560B may define angle 1540. Angle 1540 may also be an angle that is less than 180 degrees and may be an acute angle in certain embodiments. In certain embodiments, the majority of flat pattern 1500 may be convex, though perimeter portions of 1560A and 1560B may form a concave portion of flat pattern 1500. In certain embodiments, the angles of flat pattern 1500 may be as depicted in FIG. 15. In other embodiments, the angles of various portions of the flat pattern may vary from that depicted in flat pattern 1500 (e.g., by +/−20 degrees).

In certain embodiments, flat pattern 1500 may further include stitch and bend lines 1510, 1512, 1514, 1516, 1518, and 1520. In various embodiments, line 1510 may be parallel to perimeter portions 1550A and 1550B. Line 1512 may be parallel to perimeter portion 1556A. Line 1514 may be parallel to perimeter portion 1556B. Line 1516 may be disposed at a right angle to line 1510 and may be located at or near the middle of flat pattern 1500 and bifurcate flat pattern 1500 into portions 1502A and 1502B, which may be left and right portions. Line 1518 may be parallel to perimeter portion 1560B and line 1520 may be parallel to perimeter portion 1560A.

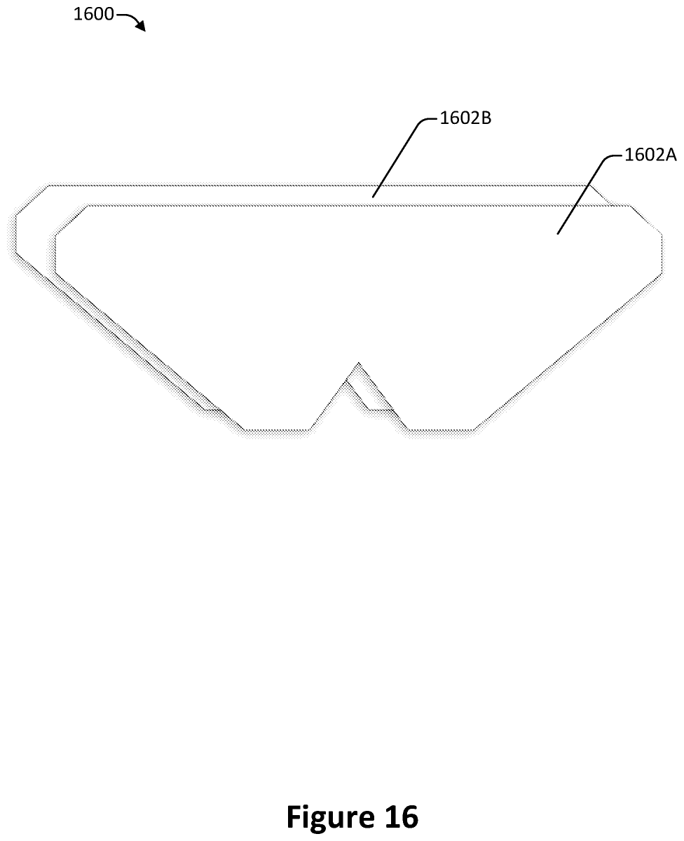

In various embodiments, such lines may be for stitching or bending of the mask, either temporarily during forming or permanently. Thus, for example, lines 1510, 1512, and 1514 may be fold lines indicating seam allowances. Folding along lines 1510, 1512, and/or 1514 allows for the creation of flaps of fabric that can then be used to sew together a plurality of flat patterns. Such processes may be further described in FIGS. 16-27.

FIGS. 16-27 illustrate various steps of a technique of manufacturing a mask, in accordance with some examples. In various embodiments, one, some, or all of the steps described in the method of FIGS. 16-27 are optional.

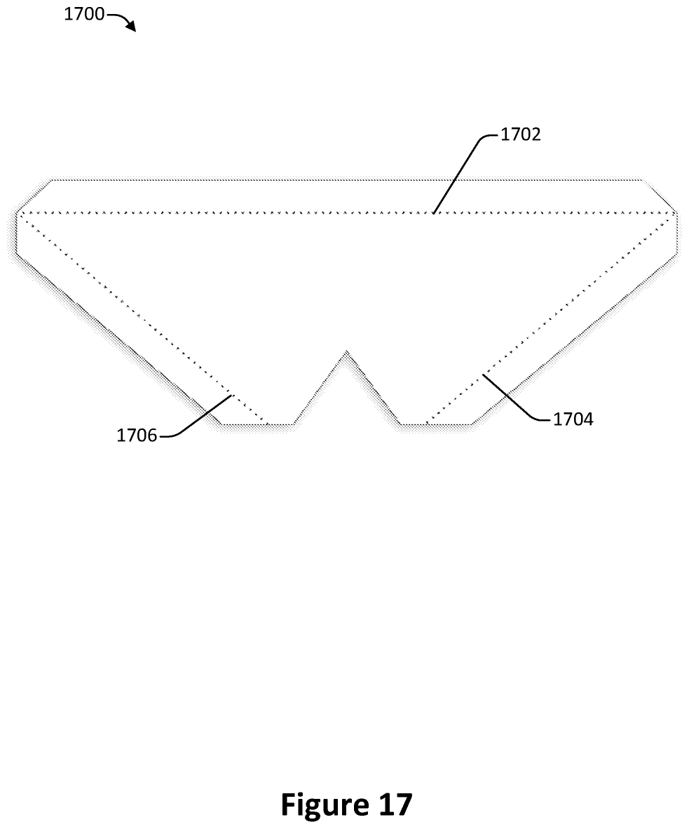

In step 1600 of FIG. 16, two flat patterns 1602A and 1602B are prepared together. In certain other embodiments, only one flat pattern is used. In other embodiments, a plurality (e.g., two, three, of four or more) of flat patterns are used. The number of flat patterns used may be dependent on, for example, the type of material used for the flat pattern and/or the desired filtering efficiency. For embodiments that utilize a plurality of flat patterns, the flat patterns may be layered on top of each other. Thus, the technique of FIGS. 17-27 may be performed with one flat pattern or a plurality of flat patterns layered on top of each other. The flat patterns used may be continuous. That is, all of the mask may be formed from a single flat pattern that is not split.

In step 1700 of FIG. 17, the two flat patterns 1602A and 1602B are sewn together. Such sewing may include stitching 1702, 1704, and 1706, which may correspond with lines 1510, 1512, and 1514 of FIG. 15.

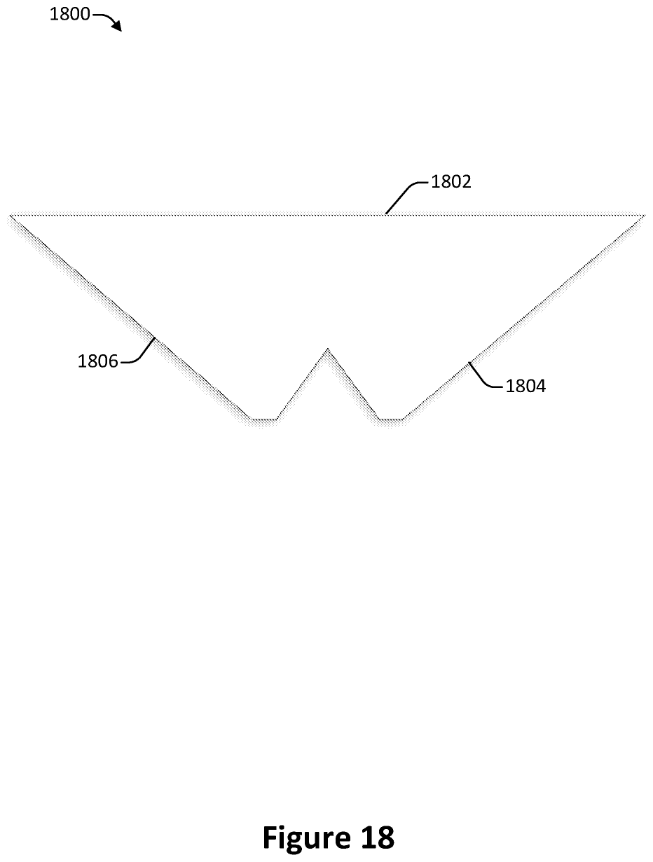

In step 1800 of FIG. 18, the stitched flat patterns may be inverted (e.g., flipped inside-out). In other embodiments, the stitched flat pattern may, additionally or alternatively, be trimmed along edges 1802, 1804, and 1806.

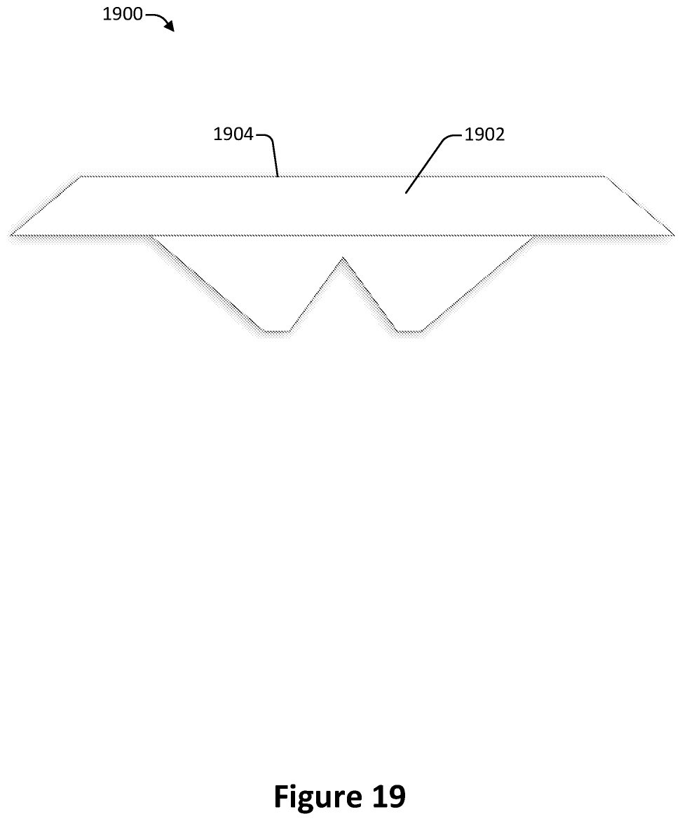

In step 1900 of FIG. 19, top portion 1902 may be folded downward along folded edge 1904. In certain embodiments, folded edge 1904 may be ironed, starched, or otherwise subjected to a technique that leaves a permanent or semi-permanent crease.

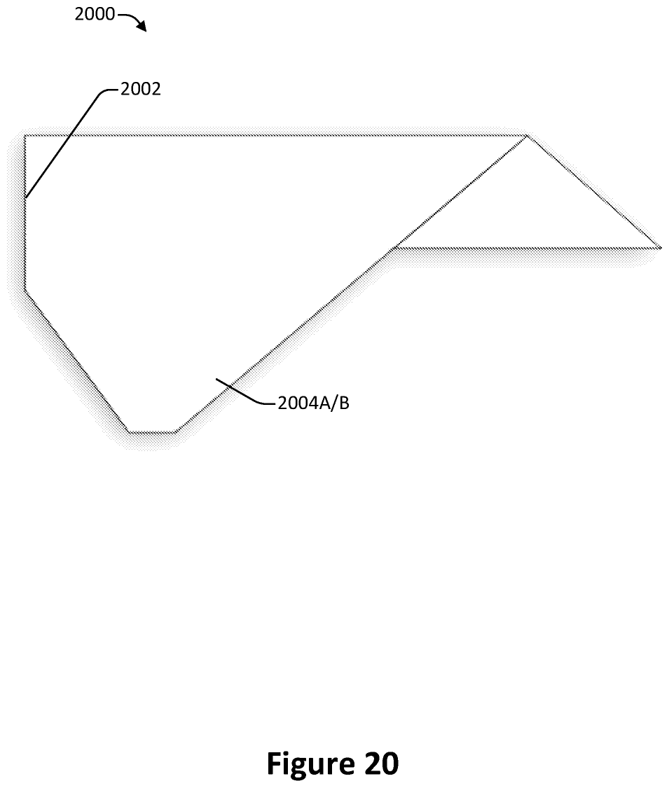

In step 2000 of FIG. 20, portions 2004A and 2004B (not shown in FIG. 20 as portion 2004B is underneath portion 2004A in FIG. 20) of the mask may be folded along centerline 2002. Centerline 2002 may correspond to line 1516 of FIG. 15. The folded crease along centerline 2002 may be ironed, starched, or otherwise subjected to a technique that leaves a permanent or semi-permanent crease.

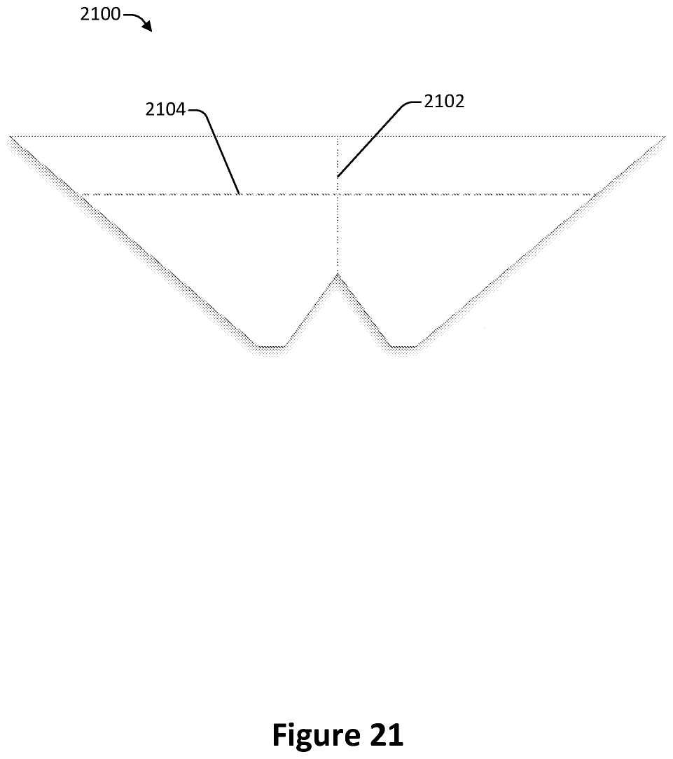

In step 2100 of FIG. 21, the mask may be unfolded with creases 2102 and 2104 visible (corresponding to centerline 2002 and folded edge 1904).

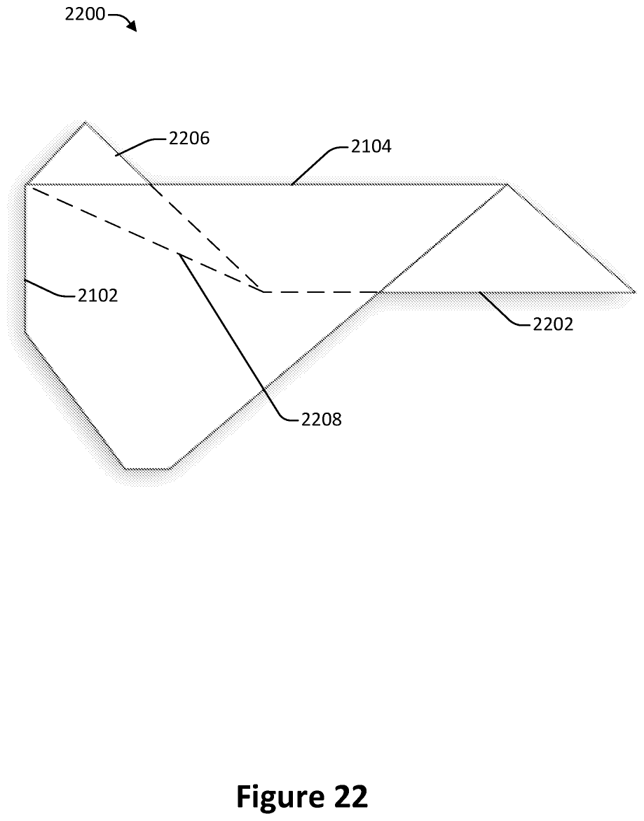

In step 2200 of FIG. 22, the mask may be again folded along creases 2102 and 2104. Nose bridge 2206 may be additionally pulled upward. In various embodiments, nose bridge 2206 may be a portion of the mask defined by the inner portion of top portion 2202 closer to the front of the mask. Nose bridge 2206 may be bent in a triangular shape, as shown and described herein, to better conform to a user's nose. The dashed lines in FIG. 22 illustrate an embodiment of how nose bridge 2206 is bent inside, including that the nose bridge includes an edge 2208 defined by bending nose bridge 2206 upward. In certain embodiments, nose bridge 2206 may be pulled upward without tearing any portion of the mask. Pulling nose bridge 2206 upward may define at least a portion of the front face of the mask.

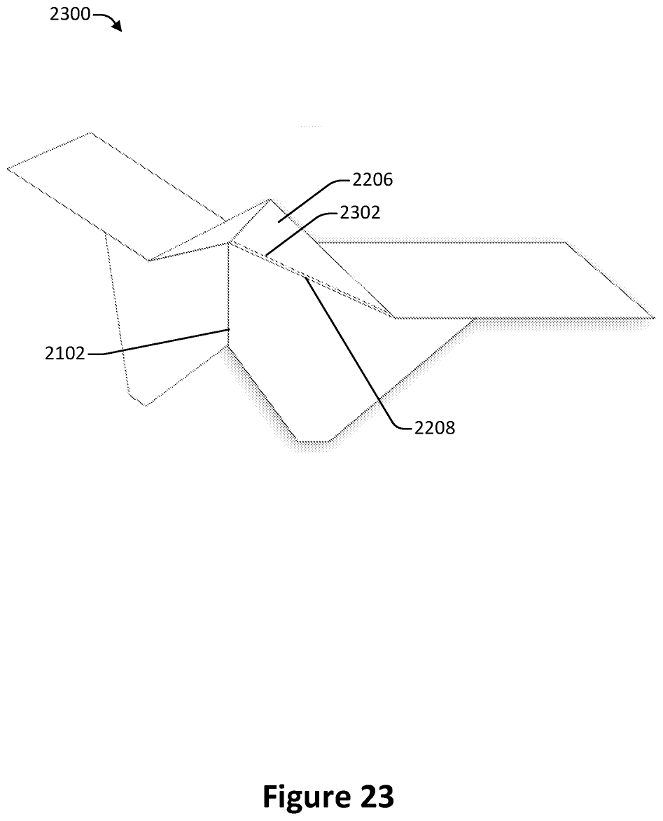

In step 2300 of FIG. 23, the bent mask is partially opened along crease 2102 to expose the inside of the mask. Stitching 2302 is applied along edge 2208 to hold nose bridge 2206 in place. The same technique may be applied to the other side of the mask.

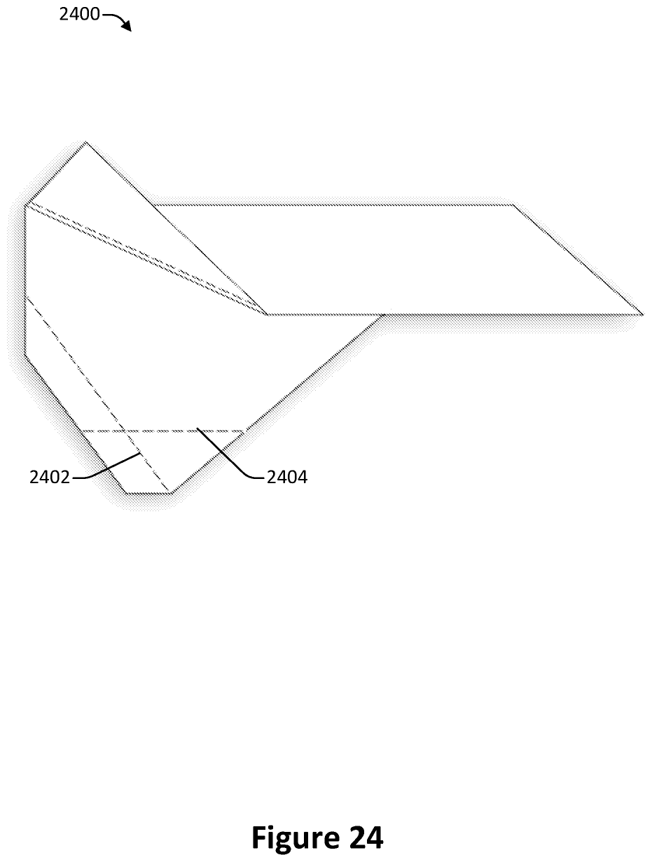

In step 2400 of FIG. 24, with the inside portions of the mask exposed, stitching 2402 and 2404 are applied along the front and bottom facing portions of the mask, respectively. Such stitching may close the front and bottom facing portions and may close up (e.g., pull in) those portions to be more conforming to a user's face. In certain other embodiments, stitching 2402 and 2404 may be combined into one curved stitch. The portions of the mask disposed towards the outside and/or the bottom of stitching 2402 and 2404 may then be pulled inward and/or cut off.

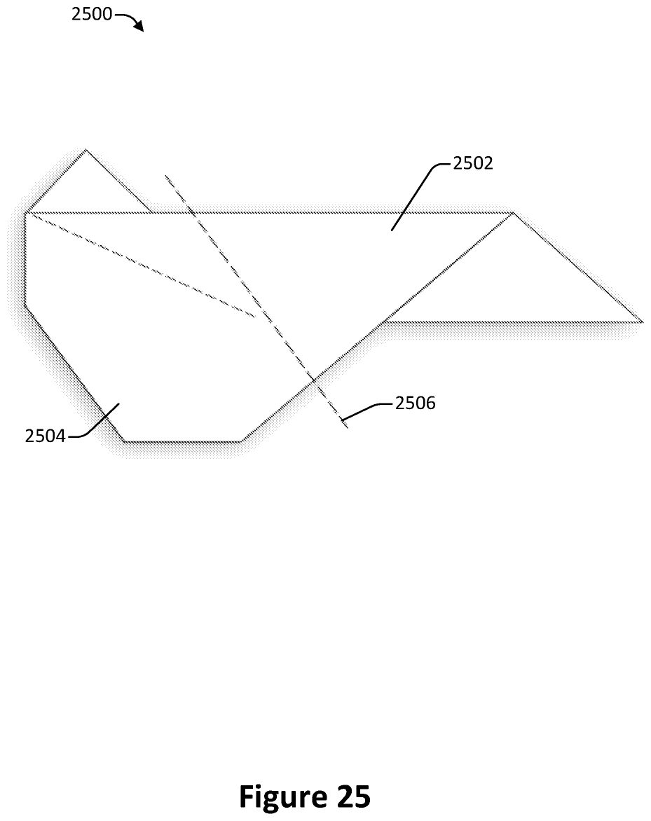

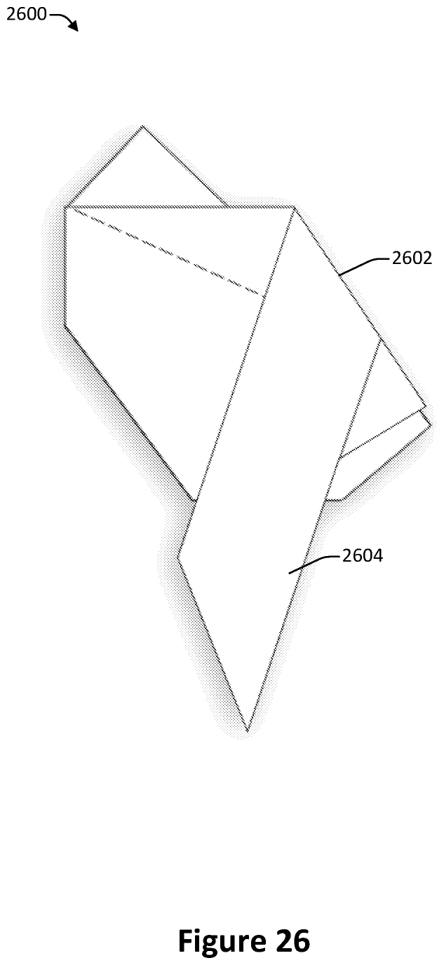

In step 2500 of FIG. 25, each side of the mask may include portions 2502 (e.g., the rearward portion) and 2504 (e.g., the forward portion). Portion 2502 may be folded downward, relative to portion 2504, along fold line 2506. In step 2600 of FIG. 26, portion 2502 may be fully folded down to form wing 2604. The folding may leave an edge 2602. Steps 2500 and 2600 of FIGS. 25 and 26 may be repeated for each side of the mask.

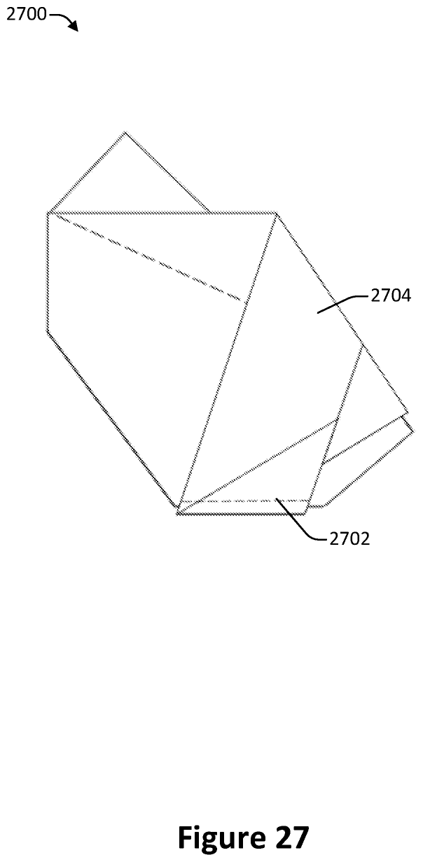

In step 2700 of FIG. 27, wings 2604 may be sewn through stitching 2702 (e.g., to each other or to another portion of the mask). Additionally, in certain embodiments, an inner pocket or a liner and/or other features, such as straps, as described herein, may be added to the mask.

Although foregoing concepts have been described in some detail for purposes of clarity of understanding, it will be apparent that certain changes and modifications may be practiced within scope of appended claims. It should be noted that there are many alternative ways of implementing processes, systems, and apparatuses. Accordingly, present examples are to be considered as illustrative and not restrictive.

1. A mask, comprising:
a front face comprising a forward facing portion and a rearward facing portion, wherein the rearward facing portion comprises a top edge;
a nose bridge, triangular in cross-section and comprising a bottom portion, wherein the bottom portion is disposed along the top edge of the rearward facing portion of the front face, and wherein the front face and the nose bridge are folded from a continuous flat pattern; and
stitching, disposed substantially parallel to the top edge and extending rearward and downward, wherein the stitching couples the front face to the nose bridge and holds in place the bottom portion of the nose bridge relative to the top edge.

2. The mask of claim 1, further comprising:
a liner, coupled to the rearward facing portion of the front face.

3. The mask of claim 2, wherein the liner comprises a pocket.

4. The mask of claim 3, further comprising:
a filter, disposed within the pocket.

5. The mask of claim 3, further comprising:
removable insulation, disposed within the pocket.

6. The mask of claim 1, wherein the front face further comprises a wing, folded downward.

7. The mask of claim 6, a strap, coupled to the wing.

8. The mask of claim 6, wherein the wing is a first wing, wherein the front face further comprises a second wing, folded downward, and wherein the first wing and the second wing are disposed on opposite sides of the front face.

9. The mask of claim 1, wherein the bottom portion and the rearward facing portion of the front face define a bend line.

10. The mask of claim 9, wherein the stitching is disposed substantially parallel to the bend line.

11. A method of forming a mask, comprising:
preparing a mask pattern, wherein the mask pattern comprises:
a first portion;
a second portion; and
a concave portion defined by at least a first perimeter portion and a second perimeter portion disposed at a first angle to the first perimeter portion, wherein the first portion and the second portion are divided by a first bend line, and wherein the first bend line divides the mask pattern into left and right portions;
bending downward a top portion of the mask pattern;
bending the mask pattern along a bend line dividing the first portion and the second portion;
pulling upward, from the mask pattern bent along the bend line, a nose bridge from the top portion that is bent downward, wherein pulling the nose bridge upward additionally defines at least a portion of a front face of the mask; and
stitching the nose bridge to the front face of the mask, wherein the stitching is substantially parallel to a top edge of the front face.

12. The method of claim 11, wherein the stitching extends rearward and downward.

13. The method of claim 11, wherein the bending downward the top portion and the bending the mask pattern along the bend line creates a second mask pattern comprising a left and right forward portions and left and right rearward portions, and wherein the method further comprises:
bending downward the left and right rearward portions to create left and right wings.

14. The method of claim 13, further comprising:
stitching together the left and right wings.

15. The method of claim 11, wherein the mask pattern further comprises:
a third perimeter portion; and
a fourth perimeter portion, collinear to the third perimeter portion and bifurcated by the bend line.

16. The method of claim 15, wherein the mask pattern further comprises:
a fifth perimeter portion, disposed at a second angle to the first perimeter portion and substantially parallel to the third perimeter portion; and
a sixth perimeter portion, disposed at a third angle to the second perimeter portion and substantially parallel to the fourth perimeter portion.

17. The method of claim 16, wherein the mask pattern further comprises:
a seventh perimeter portion, disposed at a fourth angle to the fifth perimeter portion; and
an eighth perimeter portion, disposed at a fifth angle to the sixth perimeter portion.

18. The method of claim 17, further comprising:
bending the mask pattern along a second bend line substantially parallel to the third and fourth perimeter portions.

19. The method of claim 17, further comprising:
bending the mask pattern along a third bend line substantially parallel to the seventh perimeter portion.

20. The method of claim 17, further comprising:
bending the mask pattern along a fourth bend line substantially parallel to the eighth perimeter portion.
